(19) United States
(12) Patent Application Publication
(10) Pub. No.: US 2006/0113806 A1
(43) Pub. Date: Jun. 1, 2006

(54) Wafer transfer mechanism

(75) Inventors: Naota Tsuji, Tokyo (JP); Yukihiro Mori, Tokyo (JP); Takashi Hagino, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 10/998,696

(22) Filed: Nov. 29, 2004

(51) Int. Cl. B65G 49/07

(52) U.S. Cl. 294/1.1

(57) ABSTRACT

A transfer mechanism for transferring a workpiece includes an arm member including a tip projection provided at a tip end thereof for contacting a periphery of the workpiece and restricting movement of the workpiece. The arm member further includes multiple supporting projections protruding from a top surface thereof for contacting and supporting a back side of the workpiece.

### BACKGROUND OF THE INVENTION

1. Field of the Invention

The present invention generally relates to an apparatus and a method for transferring a workpiece such as a semiconductor wafer to and from a storage section, and more particularly, relates to an apparatus and a method which can transfer a workpiece to a prescribed position in a storage section.

2. Description of the Related Art

A process of semiconductor manufacturing includes a step of transferring a sheet of semiconductor wafer from a wafer-storing cassette to a processing chamber or a step of transferring a sheet of semiconductor wafer from a processing chamber to another processing chamber. FIG. 1 is a perspective view of a conventional transfer mechanism typically used for such transferring steps. (See U.S. Pat. No. 6,305,898, the disclosure of which is incorporated herein by reference in its entirety.) The transfer mechanism 1 has an arm 2 which can hold a semiconductor wafer W at the front thereof; and has a projection 2′ having a configuration corresponding to the peripheral edge of the semiconductor wafer W provided on the end thereof. Additionally, when the arm 2 is at a retracted position, the transfer mechanism has a positioning member 10 in the vicinity of the arm.

The arm 2 is connected to a rotating mechanism 5 through two auxiliary arms 3, 4 so as to reciprocate between an extended position and the retracted position. Additionally, a guide (not shown) is provided for allowing the arm 2 to be reciprocated only in the axial direction thereof. Consequently, when the arm 4 is rotated by the rotating mechanism 5, the arm 2 can be reciprocated through the arm 3.

As illustrated in FIG. 2, a portion holding a wafer W of the arm 2 is wider than a shaft portion thereof and includes two projections 2′ at the end thereof. Since the projections 2′ come into contact with an edge of a wafer W, elastic members or soft members are provided for each wafer-contacting portion of the projections 2′ so as to prevent damaging the edge of the wafer.

The positioning member 10 is connected to the rotating mechanism 5 in the vicinity of the arm 2. The positioning member 10 comprises a horizontal portion 11 positioned above the arm 2 whose both ends are expanded and a vertical portion 12 which fixes the horizontal portion on the rotating mechanism 5. A trapezoidal recess is formed in the horizontal portion 11. On this recess, elastic pieces 13 (e.g. spring elements) are attached and come into elastic contact with an edge of a wafer W. Although the elastic pieces are preferable for elastically coming into contact with the wafer W, such pieces are not essential, and in the alternative, the trapezoidal recess of the horizontal portion may be contacted with an edge of the wafer.

When a wafer is unloaded by the conventional transfer mechanism (FIG. 1), a wafer supported by pins above a wafer stage is moved to the arm 2 by retracting pins downward. However, in a processing chamber in which a plasma, for example, is used for a given process of a wafer (e.g. plasma CVD), because a temperature of a workpiece to be transferred from the processing chamber is relatively high, the wafer W may thermally stick onto the arm 2 and cannot be slid by being pushed by the positioning member 10, thereby making it impossible to position the wafer W at a prescribed position and causing a transfer error. If the wafer's sticking is severe, the positioning member 10 is deformed and becomes unusable.

### SUMMARY OF THE INVENTION

In view of the above problem, and it is an object of the invention to provide a mechanism and a method for transferring a relatively high-temperature workpiece so as to place the workpiece at a prescribed position on an arm member holding the workpiece without any additional step.

It is another object of the invention to provide a mechanism and a method for transferring a workpiece so as to easily transfer the workpiece to an arm member and place the workpiece at a prescribed position on the arm.

It is still another object of the invention to provide a mechanism and a method for transferring a wafer so as to transfer the wafer to or from a storage section at a high speed.

It is yet another object of the invention to provide a mechanism and a method for transferring a workpiece so as to transfer the workpiece under not only a normal pressure condition but also a vacuum condition.

It is an additional object of the invention to provide a mechanism and a method for transferring a workpiece which can be adapted for existing apparatuses.

In an aspect, the present invention which can accomplish one or more of the above objects provides a transfer mechanism for transferring a workpiece, comprising: (i) an arm member comprising a tip projection provided at a tip end thereof for contacting a periphery of the workpiece and restricting movement of the workpiece, said arm member further comprising multiple supporting projections protruding from a top surface thereof for contacting and supporting a back side of the workpiece; (ii) a movement mechanism for reciprocating the arm member with the workpiece supported thereon between a retracted position and an extended position; and (iii) a positioning member for contacting a periphery of the workpiece and moving the workpiece relative to the arm member for sandwiching the workpiece between the tip projection and the position member when the arm member moves to the retracted position, wherein when the workpiece moves relative to the arm member, the workpiece slides on the supporting projections.

In the above, the supporting projections may be comprised of first supporting projection(s) and second supporting projection(s), wherein the second supporting projection(s) has a height greater than the first supporting projection(s) and is provided where the workpiece is supported upward by the first supporting projection(s) but not by the second supporting projection(s) at the retracted position.

In an embodiment, the arm member may be Y-shaped and comprise a shaft portion and two blades branching therefrom, wherein the tip projection is attached to the tip end of each blade.

In the above, the supporting projections may be constituted of at least four supporting members, wherein one is disposed in the vicinity of the tip end of each blade near an outer edge of the blade, and one is disposed in the vicinity of a bottom of each blade near the outer edge of the blade.

In the above, in the alternative, the supporting projections may be comprised of first supporting projections and second supporting projections, (a) wherein the first supporting projections comprise a distal supporting projection disposed in the vicinity of the tip end of each blade near an outer edge of the blade and a proximate supporting projection disposed in the vicinity of a bottom of each blade near the outer edge of the blade, (b) wherein the second supporting projections has a height greater than the proximate supporting projections and is disposed generally between the proximate supporting projections and outside a curved line defined by a periphery of the substrate passing through the proximate supporting projections, and (c) wherein the workpiece is placed between the second supporting projections and the tip projections and is supported on the first supporting projections at the retracted position.

In another aspect, the invention which can accomplish one or more of the above objects provides an arm member for carrying a semiconductor substrate, comprising: (I) a Y-shaped portion having a shaft and two blades branching from the shaft for supporting a substrate; (II) a tip projection provided at a tip end of each blade for contacting a periphery of the substrate and restricting movement of the substrate; and (III) multiple supporting projections protruding from a top surface of the Y-shaped portion for contacting and supporting a back side of the substrate, said supporting projections being comprised of first supporting projections and second supporting projections, (IV) wherein the first supporting projections comprise a distal supporting projection disposed in the vicinity of the tip end of each blade near an outer edge of the blade and a proximate supporting projection disposed in the vicinity of a bottom of each blade near the outer edge of the blade, and (V) the second supporting projections has a height greater than the proximate supporting projections and being disposed generally between the proximate supporting projections and outside a curved line defined by a periphery of the substrate passing through the proximate supporting projections, (VI) wherein the substrate can be placed between the second supporting projections and the tip projections when the substrate is supported on the first supporting projections.

In still another aspect, the present invention which can accomplish one or more of the above objects provides a transfer mechanism for transferring a workpiece, comprising (i) the arm member of any of the foregoing, (ii) a movement mechanism for reciprocating the arm member with the workpiece supported thereon between a retracted position and an extended position; and (iii) a positioning member for contacting a periphery of the workpiece and moving the workpiece relative to the arm member for sandwiching the workpiece between the tip projection and the position member when the arm member moves to the retracted position, wherein when the workpiece moves relative to the arm member, the workpiece slides on the supporting projections.

In yet another aspect, the present invention which can accomplish one or more of the above objects provides (A) a plasma processing chamber, (B) a thermal CVD chamber, and (C) a thermal processing chamber, each of which is provided with the transfer mechanism of any of the foregoing for transferring a workpiece to and from the chamber. In the above chamber, the arm member can effectively be used even when a temperature of the workpiece is 150° C. or higher (including 200° C., 300° C., 400° C., and ranges between any two numbers of the foregoing).

In a different aspect, the present invention which can accomplish one or more of the above objects provides a method for transferring a workpiece, comprising: (I) placing a workpiece on an arm member comprising a tip projection provided at a tip end thereof for contacting a periphery of the workpiece and restricting movement of the workpiece, said arm member further comprising multiple supporting projections protruding from a top surface thereof for contacting and supporting a back side of the workpiece; (II) moving the arm member with the workpiece supported thereon toward a retracted position; (III) contacting a periphery of the workpiece with a positioning member at the retracted position by moving the workpiece relative to the arm member whereby the workpiece is sandwiched between the tip projection and the position member; and (IV) moving the arm member with the workpiece supported thereon toward an extended position.

In the above, a temperature of the workpiece may be 150° C. or higher.

In the foregoing aspects and embodiments, any element used in an aspect or embodiment can interchangeably be used in another aspect or embodiment, and any combination of elements can be applied in any aspects or embodiments, unless application is not feasible.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 is a perspective view of a conventional transfer mechanism.

FIG. 2 is a perspective view of an arm of the conventional mechanism.

FIG. 3 is a perspective view of a transfer mechanism according an embodiment of the present invention.

FIG. 4 is a perspective view of an arm of the transfer mechanism according to an embodiment of the present invention.

FIG. 5 is a graph showing temperature-dependence of slip load of various materials.

FIG. 6 is a diagram showing a test piece for determining a slip load.

FIG. 7 is a top view of an arm member according to an embodiment of the present invention.

FIG. 8 is a side sectional view of an arm member according to an embodiment of the present invention.

Explanation of symbols used is as follows: 101: Transfer mechanism; 102: Arm; 102′: Tip projection; 103: Arm; 104: Arm; 105: Rotating mechanism; 110: Positioning member; 111: Horizontal portion; 112: Vertical portion; 113: Elastic piece; 121: Supporting projection; 121′: Second supporting projection; 201: Shaft; 202: Blade.

### DETAILED DESCRIPTION OF THE PREFERRED EMBODIMENT

As described above, in an aspect, the present invention provides a transfer mechanism for transferring a workpiece, which comprises: (i) an arm member, (ii) a movement mechanism, and (iii) a positioning member.

The arm member comprises multiple supporting projections protruding from a top surface thereof for contacting and supporting a back side of the workpiece. The supporting projections have an area contacting the back side of the workpiece, which is less than an area of the top surface of the arm member which would have been in contact with the back side of the workpiece had the supporting projections not been provided. By reducing the area contacting the back surface of the workpiece, it becomes easier to slide the workpiece on the arm member even at high temperatures. In an embodiment, the contacting area of the supporting projections may be less than 50% (including 40%, 30%, 20%, 10%, 5%, 1%, and ranges between any two numbers of the foregoing), preferably 10% or less of the contacting area of the top surface of the arm member which would have been in contact with the back surface of the workpiece had the supporting projections not been used.

The supporting projections can have various configurations including, but not limited to, a cylindrical shape, truncated corn shape, disc shape, cubic, trapezoid, longitudinal strand, short strand, etc. Preferably, these configurations have rounded edges (no sharp edges), so that the workpiece may not be scratched.

The supporting projections can be fixed to the arm member by any methods. For example, the supporting projections can be anchored in the arm member. In an embodiment, the supporting projections may be shaped in a screw having threads and a head. In that case, the arm member has holes with threads, and the supporting projections can be screwed to the holes using a screw driver or by hand (with a clean glove). In another embodiment, the supporting projections can be integrated with the arm member, and the arm member having the supporting projections can be molded.

The supporting projections are preferably made of a material having a low stationary friction coefficient and a hardness less than that of the workpiece but sufficient to prevent generation of particles, among other criteria. In an embodiment, the supporting projections have a stationary friction coefficient of 0.2 or less (including 0.175, 0.15, 0.125, 0.10, 0.05, and ranges between any two numbers of the foregoing) against a silicon wafer having a mirror finish surface at temperatures between 150° C. and 330° C. Preferably, the stationary friction coefficient is 0.15 or less at temperatures between 150° C. and 330° C. Maintaining a low stationary friction coefficient in that temperature range is effective when transferring a workpiece to and from a plasma CVD chamber, thermal CVD chamber, and other thermal processing chamber. Thermal adhesion can be effectively avoided.

If the workpiece is a silicon wafer, its hardness is about 800 HV. Thus, the hardness of the supporting projections may preferably be lower than 800 HV. However, the material should be hard enough to generate no particles when the workpiece slides thereon.

In view of the above, preferably, the supporting projections are made of glassy carbon. Grassy carbon is constituted by an amorphous structure and does not generate particles. Further, grassy carbon has no gas permeability, low thermal conductivity, high electric conductivity, and excellent thermal resistance. Incidentally, the arm member may be made of ceramic or carbon fiber.

The supporting projections are disposed where the workpiece is stably supported thereby. In this regard, three or more (e.g., an integer of 3-10) supporting projections are preferable, depending on the configuration of the arm member. There is no restriction imposed on the configuration of the arm member, but in an embodiment, the arm member may be Y-shaped and comprise a shaft portion and two blades branching therefrom, wherein the tip projection is attached to the tip end of each blade. In the above, the supporting projections may be constituted of at least four supporting members: One is disposed in the vicinity of the tip end of each blade near an outer edge of the blade, and one is disposed in the vicinity of a bottom of each blade near the outer edge of the blade.

Further, in an embodiment, the supporting projections may be comprised of first supporting projections and second supporting projections. The first supporting projections comprise a distal supporting projection disposed in the vicinity of the tip end of each blade near an outer edge of the blade and a proximate supporting projection disposed in the vicinity of a bottom of each blade near the outer edge of the blade. The second supporting projections have a height greater than the proximate supporting projections and are disposed generally between the proximate supporting projections and outside a curved line defined by a periphery of the substrate passing through the proximate supporting projections, wherein the workpiece is placed between the second supporting projections and the tip projections and is supported on the first supporting projections at the retracted position.

For example, the first supporting projections may each have a height (from the top surface) of about 0.5 mm to about 5 mm (including 1 mm, 2 mm, 3 mm, 4 mm, and ranges between any two numbers of the foregoing) and a diameter of about 3 mm to about 10 mm (including 4 mm, 5 mm, 6 mm, 7 mm, 8 mm, 9 mm, and ranges between any two numbers of the foregoing). If the supporting projections are a screw type, the length of a thread portion may be approximately the same as the thickness of a head portion which corresponds to the height described above. Additionally, for example, the second supporting projections may each have a height (from the top surface) about 0.2 mm to about 2.0 mm (including 0.5 mm, 0.7 mm, 1.0 mm, 1.5 mm, and ranges between any two numbers of the foregoing) higher than the first supporting projections.

If the top surface of the arm member is not leveled, the height of the first supporting projections can be adjusted so as to level the workpiece over the arm member.

Incidentally, the positioning member may be constituted by an elastic body such as polybenzimidazole (PBI) which has thermal resistance at 300-400° C.

When the arm member is moved to the retracted position by the movement mechanism, the positioning member comes into contact with the edge of the workpiece held on the arm member to block only the movement of the workpiece and to slide the workpiece on the supporting projections, thereby placing the workpiece at the prescribed position on the arm member.

In order to transfer a workpiece from one storage section to another storage section, the movement mechanism includes moving means for moving the arm member to each storage section while keeping the arm member in its retracted position. The positioning member is connected to the moving means.

The present invention will be explained in more detail with reference to the drawings. However, the drawings and embodiments described below do not intend to limit the present invention, and the present invention can be accomplished by modifying the embodiments and drawings.

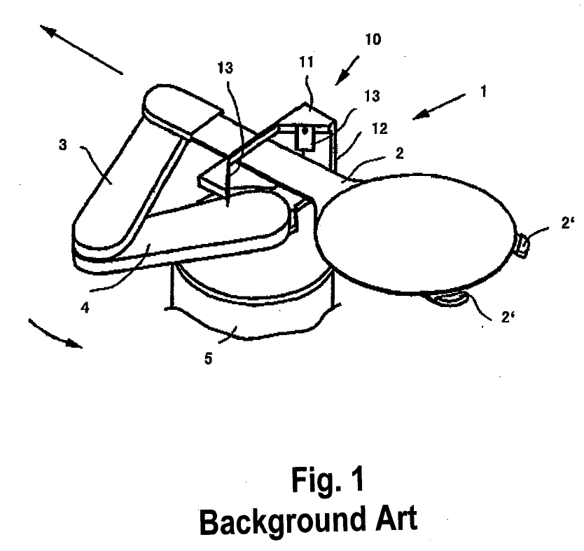

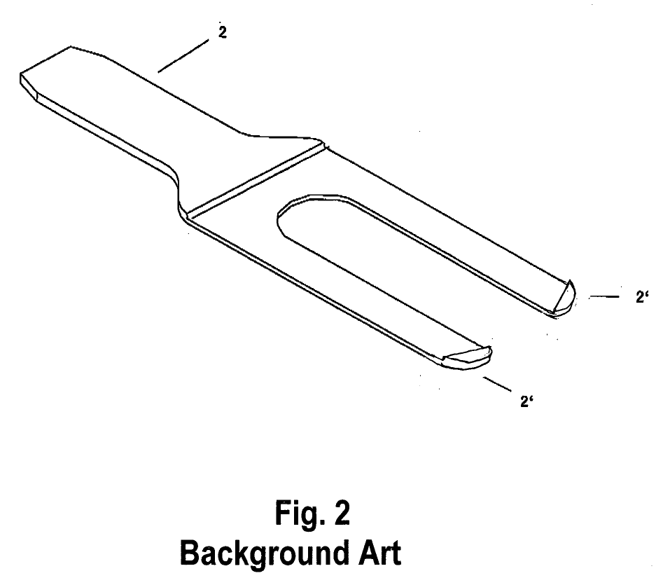

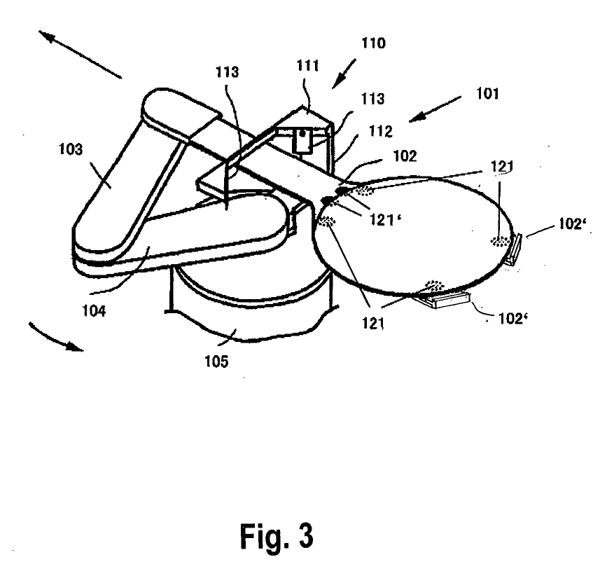

FIG. 3 is a perspective view of the transfer mechanism 101 according to an embodiment of the present invention. It is different from the transfer mechanism 1 of the conventional mechanism shown in FIG. 1 that it includes supporting projections 121, 121′ for sliding a workpiece.

As described with reference to FIG. 1, the arm 102 of the transfer mechanism 101 according to this embodiment of the present invention is also connected to a rotating mechanism 105 through two auxiliary arms 103 and 104 so as to reciprocate between an extended position and a retracted position. The auxiliary arms may not be necessary depending on the configuration of the moving mechanism, and the number of the auxiliary arms can vary (e.g., 1, 2, 3, or 4). Additionally, a guide (not shown) is provided for allowing the arm 102 to be reciprocated only in the axial direction thereof. Consequently, when the arm 104 is rotated by the rotating mechanism 105, the arm 102 can be reciprocated through the arm 103.

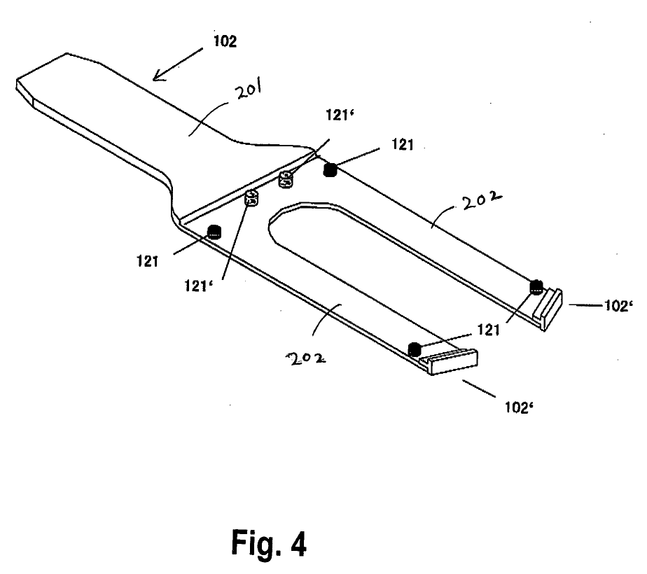

As illustrated in FIG. 4, a portion holding a wafer W of the arm 102 (two blades 202) is wider than a shaft portion 201 thereof and includes two tip projections 102′ at the end of the blades 202. Since the tip projections 102′ come into contact with an edge of a wafer W, it is desirable to provide elastic members (e.g., spring members or a heat-resistant resin) on each wafer-contacting portion thereof so as to prevent damaging the edge of the wafer. Additionally, the arm 102 includes first supporting projections 121 and second supporting projections 121′ for holding a workpiece and sliding the workpiece thereon by being pushed by the positioning member 110. The second supporting projections 121′ can be omitted.

The positioning member 110 is connected to the rotating mechanism 105 in the vicinity of the arm 102. The positioning member 110 comprises a horizontal portion 111 positioned above the arm 2 whose both ends are expanded and a vertical portion 112 which fixes the horizontal portion on the rotating mechanism 105. A trapezoidal recess is formed in the horizontal portion 111. On this recess, elastic pieces 113 coming into contact with an edge of the wafer (e.g. spring elements or spring elements whose portions coming into contact with the edge of a wafer are made of a heat-resistant resin such as PBI) are attached. Although the elastic pieces are preferable for elastically contacting a wafer W, such pieces are not essential, and in the alternative, the trapezoidal recess of the horizontal portion may be contacted with an edge of a wafer.

While the horizontal portion 111 is formed with the trapezoidal recess to be in contact with an edge of a wafer at two positions as the illustrated, the horizontal portion 111 may be designed so as to be in contact with a wafer at only one position or more than three positions. As the number of such contact positions is increased, it is easier to position a wafer W at a prescribed position on the arm 102. However, it becomes difficult to accommodate a wafer having different diameter.

In the transfer mechanism 101 having the positioning member 110, when the arm 104 is rotated by the rotating mechanism 105 so as to retract the arm 102 through the arm 103, the wafer W held on the first supporting projections 121 and the second supporting projections 121′ is retracted together with the arm 102 and is then brought into contact with elastic members 113 of the positioning member 110. When the arm 102 is further retracted, the positioning member 110 blocks the wafer W so as not to move with the arm. Consequently, the wafer W is pushed toward the tip projections 102′ of the arm on the first supporting projections 121 and the second supporting projections 121′ and is then sandwiched between the tip projections 102′ and the elastic members 113 of the positioning member. It is understood that if this wafer position is made to correspond to a prescribed position of the wafer on the arm 102, the wafer is always positioned at the prescribed position by retracting the arm 102. Additionally, when the wafer W is positioned at the prescribed position, the wafer comes off from the second supporting projections 121′; the second supporting projections 121′ work as stoppers for the wafer W using height difference between the first supporting projections 121 and the second supporting projections 121′.

Since the wafer W is secured at the prescribed position on the arm 102 by the tip projections 102′ and the positioning member 110, the wafer W will not be dislocated from the prescribed position, even though the transfer mechanism 101 is rotated at a high speed or is translated as a whole (not shown).

Additionally, in an embodiment, it is an object of the invention to provide a mechanism and a method for transferring a workpiece so as to place the workpiece at a prescribed position on an arm member for holding the workpiece without any additional step, even though a temperature of the workpiece to be transferred to and from a storage section is 150° C. and above, and it is essential that the workpiece can be slid smoothly on the supporting projections 121 and the second supporting projections 121′.

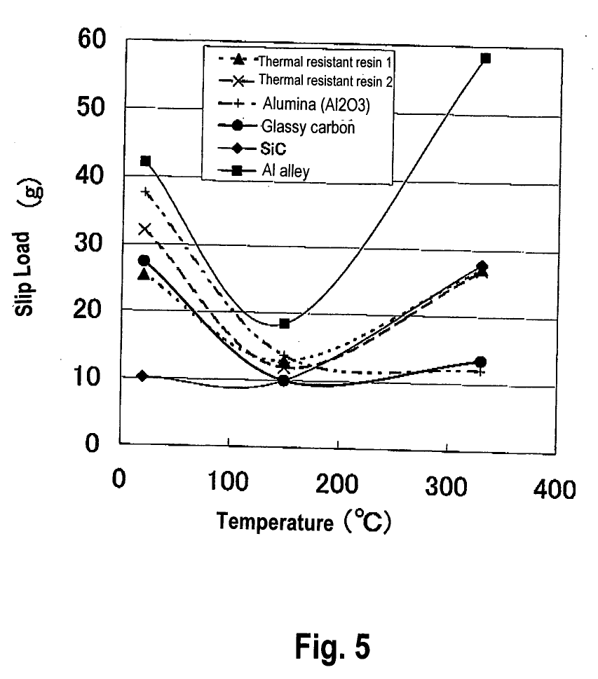

In order to select a material for the first supporting projections 121 and the second supporting projections 121′, considerations about the following characters of the material are required:
Low friction factor
High upper temperature limit and no friction increase occurring at a high temperature. (See FIG. 5 Temperature-dependence of Slip Load.)
No indication of glass transition and no stickiness at a high temperature.
High electric conductivity and static-free.
It does not damage the back side of a wafer. (The back side of a wafer is damaged if SiC or Al₂O₃ is used as a material of the wafer.)

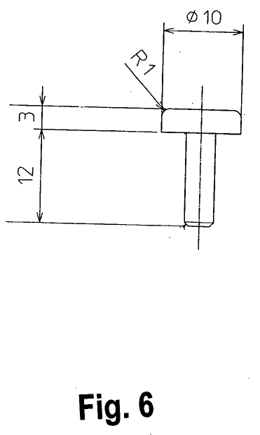

In the above, low friction factor means a low stationary friction coefficient measured based on a slip load as follows:
1) A test piece made of a material-to-be-tested is prepared (see FIG. 6). The contacting area of the test piece is 50.24 mm². Three test pieces will be used.
2) A susceptor in which a heater is embedded is provided. The susceptor has three lift pin holes disposed symmetrically with respect to the center in a triangle arrangement having a length of 160.21 mm per side.
3) The three test pieces are placed in the respective lift pin holes.
4) A silicon wafer having a diameter of 300 mm, a thickness of 775±25 μm, and a weight of 127 g is provided. The wafer has a mirror finish back surface (Ra≦0.01 μm).
5) A push-pull gage is connected to a periphery of the wafer. The wafer is then placed on the three test pieces and the temperature of the wafer is controlled. The wafer is placed horizontally.
6) The wafer is pulled horizontally using the gage, and a slip load is measured at the controlled temperature.

In the above, 127 g (the weight of the wafer) is vertical force (N), and the slip load is horizontal force (f) when the wafer starts slipping. Thus, stationary friction coefficient η can be expressed as η=f/N.

Preferably, the supporting projections have a stationary friction coefficient of 0.2 or less (including 0.175, 0.15, 0.125, 0.10, 0.05, and ranges between any two numbers of the foregoing) against a silicon wafer having a mirror finish surface at temperatures between 150° C. and 330° C.

FIG. 5 is a graph showing temperature-dependent slip loads of various materials. Thermal resistant resin 1 is PBI, and thermal resistant resin 2 is Vespel®. As can be seen from the graph, the stationary friction coefficients of the thermal resistant resins, SiC, and Al alloy (A6061) increase as the temperature increases from 150° C. to 330° C. In contrast, the stationary friction coefficients of glassy carbon (manufactured by Tokai Carbon Co., Ltd., Tokyo) and alumina do not significantly increase even when the temperature increases from 150° C. to 330° C. When the slip load is 20 g, the stationary friction coefficient is calculated at 0.157 (20/127). The glassy carbon and the alumina have a stationary friction coefficient of 0.2 or less (25.4 g or less) at temperatures of 150° C. to 330° C.

Further, preferably, the material shows no glass transition up to a temperature of 300° C. The electric conductivity of the material can be evaluated by an electric resistance which is preferably 10² Ω·cm or less (e.g., 1 Ω·cm or less) which is nearly equivalent to or less than that of a silicon wafer. For example, glassy carbon has an electric resistance of 4.2×10⁴ Ω·cm.

As a result of examination including FIG. 5, glassy carbon is preferable.

In addition, tests were conducted using arm members made of ceramic and carbon fiber; both materials produced excellent results in evaluation of with/without transfer troubles, particle generation on the right side of a wafer, particle generation on the wrong side of a wafer, damage on the wrong side of a wafer, and deposition performance.

In the case of transferring a semiconductor wafer, because particle generation is a serious problem, a transfer speed, a shape of the arm, and a shape of the projections, the supporting projections, or the positioning member coming into contact with a wafer will be determined appropriately so as not to generate particles.

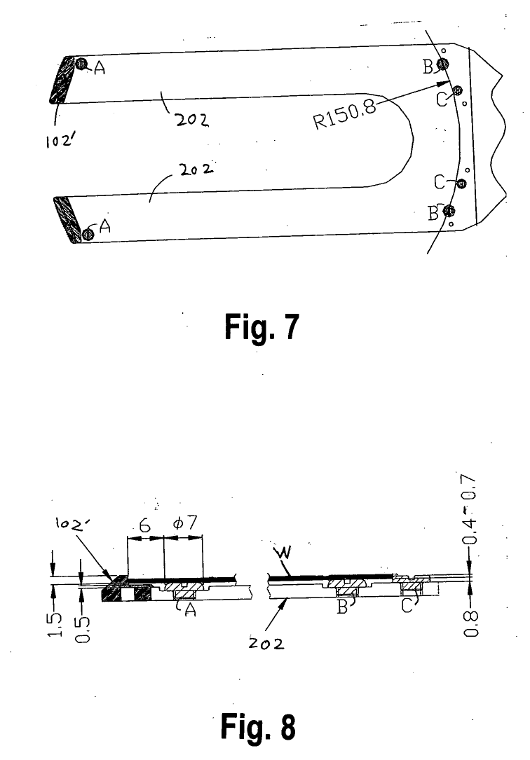

FIGS. 7 and 8 show an embodiment of the arm member using the first supporting projections A and B and the second supporting projections C made of glassy carbon. At the tip end of the blade 202, the tip projection 102′ is attached. This tip projection 102′ has a configuration different from that indicated in FIG. 4. As shown in FIG. 7, the second supporting projections C are disposed outside a curved line (R150.8) defined by a periphery of a silicon wafer W which passes through the first supporting projections B. The distal supporting projections A are disposed in the vicinity of the tip projections 102′. In this embodiment, the first and second supporting projections A, B, and C are of a screw type, and the heads of the first supporting projections A and B are more rounded than the head of the second supporting projections C. However, the configuration of the projections should not be limited the screw type. In FIGS. 7 and 8, the measurements are indicated but do not intend to limit the present invention. In these configurations, the measurements may vary by ±50% or less. The wafer W can be fitted between the tip projections 102′ and the second supporting projections C.

As explained above, according to at least one embodiment of the present invention, even though a temperature of a workpiece to be transferred to and from the storage section is relatively high, the wafer W can be slid smoothly on the supporting projections by being pushed by the positioning member without thermally sticking onto the supporting projections so as to allow the wafer to be placed at a prescribed position.

Since a workpiece is held without using suction, it is applicable to transfer the workpiece under not only a normal pressure condition but also a vacuum condition.

The present invention can be implemented using an existing transfer mechanism which uses an arm member with substantially no modification thereof, although supporting projections are required.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A transfer mechanism for transferring a workpiece, comprising:
an arm member comprising a tip projection provided at a tip end thereof for contacting a periphery of the workpiece and restricting movement of the workpiece, said arm member further comprising multiple supporting projections protruding from a top surface thereof for contacting and supporting a back side of the workpiece;
a movement mechanism for reciprocating the arm member with the workpiece supported thereon between a retracted position and an extended position; and
a positioning member for contacting a periphery of the workpiece and moving the workpiece relative to the arm member for sandwiching the workpiece between the tip projection and the position member when the arm member moves to the retracted position, wherein when the workpiece moves relative to the arm member, the workpiece slides on the supporting projections.

2. The transfer mechanism according to claim 1, wherein the supporting projections are comprised of first supporting projection(s) and second supporting projection(s), said second supporting projection(s) having a height greater than the first supporting projection(s) and being provided where the workpiece is supported upward by the first supporting projection(s) but not by the second supporting projection(s) at the retracted position.

3. The transfer mechanism according to claim 1, wherein the supporting projections are constituted by cylindrical pieces.

4. The transfer mechanism according to claim 1, wherein the supporting projections have an area contacting the back side of the workpiece, which is less than 10% of an area of the top surface of the arm member which would have been in contact with the back side of the workpiece had the supporting projections not been provided.

5. The transfer mechanism according to claim 1, wherein the supporting projections have (i) a stationary friction coefficient of 0.15 or less against a silicon wafer having a mirror finish surface at temperatures between 150° C. and 330° C., and (ii) a hardness less than that of a silicon wafer.

6. The transfer mechanism according to claim 5, wherein the supporting projections are made of glassy carbon.

7. The transfer mechanism according to claim 1, wherein the arm member is made of ceramic or carbon fiber.

8. The transfer mechanism according to claim 1, wherein the positioning member is constituted by an elastic body.

9. The transfer mechanism according to claim 1, wherein the arm member is Y-shaped and comprises a shaft portion and two blades branching therefrom, said tip projection being attached to the tip end of each blade.

10. The transfer mechanism according to claim 9, wherein the supporting projections are constituted of at least four supporting members, one being disposed in the vicinity of the tip end of each blade near an outer edge of the blade, and one being disposed in the vicinity of a bottom of each blade near the outer edge of the blade.

11. The transfer mechanism according to claim 9, wherein the supporting projections are comprised of first supporting projections and second supporting projections, said first supporting projections comprising a distal supporting projection disposed in the vicinity of the tip end of each blade near an outer edge of the blade and a proximate supporting projection disposed in the vicinity of a bottom of each blade near the outer edge of the blade, said second supporting projections having a height greater than the proximate supporting projections and being disposed generally between the proximate supporting projections and outside a curved line defined by a periphery of the substrate passing through the proximate supporting projections, wherein the workpiece is placed between the second supporting projections and the tip projections and is supported on the first supporting projections at the retracted position.

12. The transfer mechanism according to claim 1, wherein the supporting projections are anchored in the arm member.

13. The transfer mechanism according to claim 12, wherein the supporting projections are shaped in a screw having threads and a head.

14. An arm member for carrying a semiconductor substrate, comprising:
a Y-shaped portion having a shaft and two blades branching from the shaft for supporting a substrate;
a tip projection provided at a tip end of each blade for contacting a periphery of the substrate and restricting movement of the substrate; and
multiple supporting projections protruding from a top surface of the Y-shaped portion for contacting and supporting a back side of the substrate, said supporting projections being comprised of first supporting projections and second supporting projections,
said first supporting projections comprising a distal supporting projection disposed in the vicinity of the tip end of each blade near an outer edge of the blade and a proximate supporting projection disposed in the vicinity of a bottom of each blade near the outer edge of the blade,
said second supporting projections having a height greater than the proximate supporting projections and being disposed generally between the proximate supporting projections and outside a curved line defined by a periphery of the substrate passing through the proximate supporting projections, wherein the substrate can be placed between the second supporting projections and the tip projections when the substrate is supported on the first supporting projections.

15. The arm member according to claim 14, wherein the supporting projections are constituted by cylindrical pieces.

16. The arm member according to claim 14, wherein the supporting projections have an area contacting the back side of the substrate, which is less than 10% of an area of the top surface of the arm member which would have been in contact with the back side of the substrate had the supporting projections not been provided.

17. The arm member according to claim 14, wherein the supporting projections have (i) a stationary friction coefficient of 0.15 or less against a silicon wafer having a mirror finish surface at temperatures between 150° C. and 330° C., and (ii) a hardness less than that of a silicon wafer.

18. The arm member according to claim 17, wherein the supporting projections are made of glassy carbon.

19. The arm member according to claim 14, wherein the arm member is made of ceramic or carbon fiber.

20. A transfer mechanism for transferring a workpiece, comprising the arm member of claim 14, a movement mechanism for reciprocating the arm member with the workpiece supported thereon between a retracted position and an extended position; and a positioning member for contacting a periphery of the workpiece and moving the workpiece relative to the arm member for sandwiching the workpiece between the tip projection and the position member when the arm member moves to the retracted position, wherein when the workpiece moves relative to the arm member, the workpiece slides on the supporting projections.

21. A plasma processing chamber provided with the transfer mechanism of claim 1 for transferring a workpiece to and from the chamber.

22. A thermal CVD chamber provided with the transfer mechanism of claim 1 for transferring a workpiece to and from the chamber.

23. A thermal processing chamber provided with the transfer mechanism of claim 1 for transferring a workpiece to and from the chamber.

24. A method for transferring a workpiece, comprising:
placing a workpiece on an arm member comprising a tip projection provided at a tip end thereof for contacting a periphery of the workpiece and restricting movement of the workpiece, said arm member further comprising multiple supporting projections protruding from a top surface thereof for contacting and supporting a back side of the workpiece;
moving the arm member with the workpiece supported thereon toward a retracted position;
contacting a periphery of the workpiece with a positioning member at the retracted position by moving the workpiece relative to the arm member whereby the workpiece is sandwiched between the tip projection and the position member; and
moving the arm member with the workpiece supported thereon toward an extended position.

25. The method according to claim 24, wherein a temperature of the workpiece is 150° C. or higher.

26. The method according to claim 24, wherein the supporting projections are comprised of first supporting projections and second supporting projections, said first supporting projections comprising a distal supporting projection disposed in the vicinity of the tip end of each blade near an outer edge of the blade and a proximate supporting projection disposed in the vicinity of a bottom of each blade near the outer edge of the blade, said second supporting projections having a height greater than the proximate supporting projections and being disposed generally between the proximate supporting projections and outside a curved line defined by a periphery of the substrate passing through the proximate supporting projections, wherein the workpiece is placed between the second supporting projections and the tip projections and is supported on the first supporting projections at the retracted position.

27. The method according to claim 24, wherein a workpiece is transferred to and from a plasma CVD chamber.

28. The method according to claim 24, wherein a workpiece is transferred to and from a thermal CVD chamber.

29. The method according to claim 24, wherein a workpiece is transferred to and from a thermal processing chamber.
